(19) United States
(12) Patent Application Publication
(10) Pub. No.: US 2008/0136618 A1
(43) Pub. Date: Jun. 12, 2008

(54) Control method of rear lamp for preventing crash

(76) Inventor: Jong Bae Park, Seoul (KR)

Correspondence Address: MORGAN, LEWIS & BOCKIUS LLP (SF), One Market, Spear Street Tower, Suite 2800, San Francisco, CA, 94105, US

(21) Appl. No.: 11/712,319

(22) Filed: Feb. 28, 2007

(30) Foreign Application Priority Data
Dec. 8, 2006 (KR) 10-2006-0124670

(51) Int. Cl. B60Q 1/44

(52) U.S. Cl. 340/479

(57) ABSTRACT

A control method of a brake lamp and a center high mounted stop lamp (CHMSL) of a vehicle. If the vehicle is not braking, both lamps are turned off. If the vehicle is braking, the method includes: receiving data on an operating state of the vehicle; determining a degree of danger based on the data; and operating the lamps based on the degree of danger. Operating the lamps includes: if the degree of danger is high, flashing the brake lamp quickly with high brightness, and flashing the CHMSL; if the degree of danger is medium, flashing the brake lamp slowly with high brightness, and turning on the CHMSL; and if the degree of danger is low, turning on both lamps. The data include an anti-lock brake operating state, deceleration of the vehicle, lateral acceleration of the vehicle, speed of the vehicle, and/or distance to a front obstacle.

### CROSS-REFERENCE TO RELATED APPLICATION

This application claims priority to and the benefit of Korean Patent Application No. 10-2006-0124670 filed in the Korean Intellectual Property Office on Dec. 8, 2006, the entire contents of which are incorporated herein by reference.

### BACKGROUND OF THE INVENTION

(a) Field of the Invention

The present invention relates to a control method of a warning device of a vehicle, such as a brake lamp, and more particularly, to a control method of a warning device with several operational states, each indicating a different degree of danger.

(b) Description of the Related Art

Generally, a brake lamp indicates deceleration to a driver of a rear vehicle, who can take suitable action to prevent an accident. A traditional brake lamp has only two operational states: on and off, and has no way of conveying degrees of danger.

### SUMMARY OF THE INVENTION

The present invention provides a control method of a warning device, such as a brake lamp, that conveys varying degrees of danger with several operational states.

An exemplary embodiment of the present invention provides a control method of two warning devices of a vehicle, such as a brake lamp and a center high mounted stop lamp (CHMSL). If the vehicle is not braking, both lamps are turned off. If the vehicle is braking, the method may include: receiving data on an operating state of the vehicle; determining a degree of danger based on the data; and operating the lamps based on the degree of danger.

The operating the lamps may include: if the degree of danger is high, flashing the brake lamp at a high speed with high brightness, and flashing the CHMSL; if the degree of danger is medium, flashing the brake lamp at a low speed with high brightness, and turning on the CHMSL; and if the degree of danger is low, turning on both lamps.

The data used to determine the degree of danger may include an anti-lock brake operating state, deceleration of the vehicle, lateral acceleration of the vehicle, speed of the vehicle, and/or distance to a front obstacle.

### BRIEF DESCRIPTION OF THE DRAWING

FIG. 1 is a flow chart of a control method of a brake lamp according to an exemplary embodiment of the present invention.

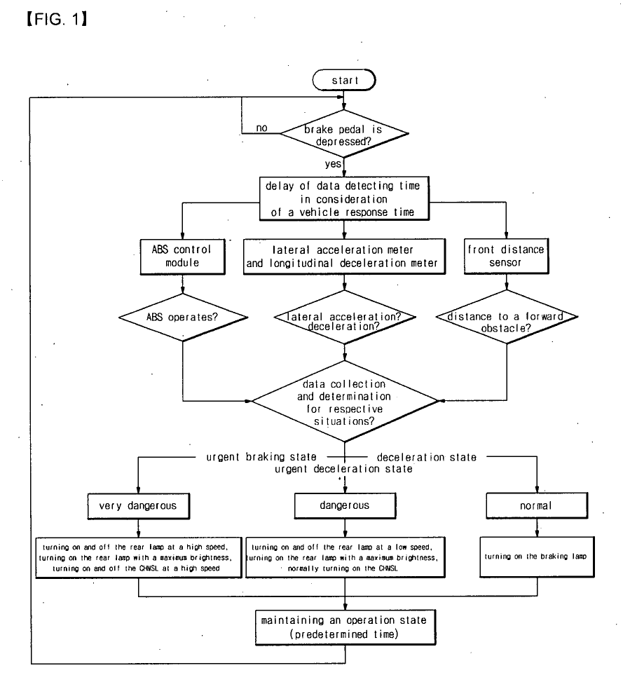

### DETAILED DESCRIPTION OF THE PREFERRED EMBODIMENTS

An exemplary embodiment of the present invention will hereinafter be described in detail with reference to the accompanying drawings.

First, a signal reflecting an operating state of a brake pedal is generated. Various sensors and signal processing blocks are also provided to detect other driving conditions. Data are obtained from the sensors via a time delay block.

The sensors may include an ABS control module, which indirectly senses road conditions, friction states during braking, etc. If the ABS is operating, the method may determine that an urgent braking state exists.

The sensors may further include a deceleration meter and/or a lateral acceleration meter. If deceleration is high, the method may determine that an urgent braking state exists.

The sensors may further include a speedometer. If the input speed value is greater than a predetermined reference value, the method may determine that an urgent braking state exists.

The sensors may further include a front distance sensor that detects distance to front obstacles in the three lanes immediately surrounding the vehicle. This distance can be compared to a calculated braking distance, or to a predetermined reference value. If the distance value is less than the braking distance or the predetermined reference value, the method may determine that an urgent braking state exists.

The signals from the sensors are compared with predetermined reference values through data collection and determination blocks for several situations. Degree of danger is then determined, and a warning device, such as a brake lamp, is operated differently based on the result of the determination. For example, the operational state of the warning device may be divided into three “on” states: a very dangerous state, a dangerous state, and a normal braking state. In addition, if the vehicle is not braking, the warning device is turned off.

Finally, an operational state maintaining block maintains the operational state for a predetermined time.

In an exemplary embodiment, the warning device includes a brake lamp and a center high mounted stop lamp (CHMSL). In the very dangerous state, the brake lamp may flash on and off at a high speed at maximum brightness, and the CHMSL may flash on and off at a high speed. Accordingly, drivers of vehicles behind the vehicle in question can easily recognize the urgent braking state of the vehicle in front of them.

In the dangerous state, the brake lamp may flash on and off at a low speed at maximum brightness, and the CHMSL may be turned on.

In the normal braking state, the brake lamp and CHMSL may be turned on.

According to an exemplary embodiment of the present invention, degree of danger during braking is determined, and different operational states are performed according to the result of the determination, so a driver of the rear vehicle can easily recognize a dangerous state.

Accordingly, accidents with the rear vehicle can be decreased. In experiments, reaction time decreased by 150 ms during the day and by 260 ms at night, corresponding to decreases in idle running distance by 3.1 m and 4.6 m, respectively, at 80 km/h.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit

What is claimed is:

1. A control method of a warning device of a vehicle, comprising:
if the vehicle is not braking, turning off the warning device; and
if the vehicle is braking:
receiving data on an operating state of the vehicle;
determining a degree of danger based on the data; and
operating the warning device based on the degree of danger.

2. The method of claim 1, wherein the warning device comprises a lamp.

3. The method of claim 2, wherein the operating the warning device comprises:
if the degree of danger is high, flashing the lamp at a high speed with a high brightness;
if the degree of danger is medium, flashing the lamp at a low speed with the high brightness; and
if the degree of danger is low, turning on the lamp at a low brightness.

4. The method of claim 1, wherein the data comprise at least one member of the group consisting of an anti-lock brake operating state; a deceleration of the vehicle; a lateral acceleration of the vehicle; a speed of the vehicle; and a distance to a front obstacle.

5. The method of claim 1, wherein the warning device comprises a plurality of warning devices.

6. The method of claim 5, wherein the warning devices comprise a first and a second lamp.

7. The method of claim 6, wherein the operating the warning devices comprises:
if the degree of danger is high, flashing the first and second lamps;
if the degree of danger is medium, flashing the first lamp and turning on the second lamp; and
if the degree of danger is low, turning on the first and second lamps.

8. The method of claim 6, wherein the first lamp is a brake lamp and the second lamp is a center high mounted stop lamp.
